(19) United States
(12) Patent Application Publication
(10) Pub. No.: US 2007/0067566 A1
(43) Pub. Date: Mar. 22, 2007

(54) External storage device for controlling computer and method thereof

(75) Inventor: Ming-Chiao Ho, Jhonghe City (TW)

Correspondence Address: BACON & THOMAS, PLLC, 625 SLATERS LANE, FOURTH FLOOR, ALEXANDRIA, VA, 22314, US

(73) Assignee: DOTOP TECHNOLOGY INC., Taipei (TW)

(21) Appl. No.: 11/501,804

(22) Filed: Aug. 10, 2006

(30) Foreign Application Priority Data
Sep. 18, 2005 (TW) 094140526

(51) Int. Cl. G06F 12/00

(52) U.S. Cl. 711/115

(57) ABSTRACT

The present invention is to provide an external storage device for controlling computer and method thereof. A message monitoring program is installed in the computer after the external storage device is connected to the computer. Thus, a user may operate an input member of the external storage device to cause the external storage device to generate a control instruction and send same to the computer. The message monitoring program runs a target program of the external storage device based on kinds of the control instruction. Therefore, the target program is adapted to cause the computer to perform a corresponding operation by running a selected one of its procedures.

### FIELD OF THE INVENTION

The present invention relates to external storage devices and more particularly to such an external storage device having a USB connector (e.g., USB type A connector) adapted to plug into a computer for controlling same and a method thereof.

### BACKGROUND OF THE INVENTION

Technologies have known a rapid, spectacular development in recent several decades. A variety of advanced electronic products are widely used by people, resulting in a significant improvement of living quality. For example, a type of external storage device called pen drive is commercially available. The compact pen drive brings a lot of convenience to people in storing files, especially large files. An external storage device, as self-explanatory, means that it is a storage device portable and highly compatible with many types of computers. Thus, a person may carry the external storage device to store files including, but not limited to, image files, text files, audio files, ad video files, from one computer for backup in a secure fast way. Further, a person may carry the external storage device to store the backup files on another computer and vice versa. Capacity of an external storage device is increased significantly due to advancements in the manufacturing technology and material science.

In view of the high-capacity of external storage device, more and more computer manufacturers and companies adopt external storage devices (e.g., an external diskette drive, an external CD-ROM drive, etc.) as standard storage devices rather than traditional internal storage devices (e.g., a diskette drive, a CD-ROM drive, etc.) in developing and manufacturing computers (e.g., notebook computers). This is because the internal storage devices are heavy and bulky (e.g., having a diameter of 5.25-inch). Thus, the manufacturers and companies must employ large molds to manufacture traditional computers. Advantageously, the development of external storage device makes it possible of employing small molds to design and manufacture computers for the manufacturers and companies of the art. Further, both computer weight and manufacturing cost are decreased significantly. Furthermore, these external storage devices are optional and thus a person may have a selection of buying one or more external storage devices depending on his or her needs.

However, a typical external storage device is capable of connecting to a computer only. Once connected, a user may transfer files stored on the external storage device to the computer or vice versa. This unfortunately not only limits applications of external storage device but also decreases the number of available functionalities of external storage device bought by a consumer. It is thus advantageous of enabling a user to carry an external storage device and connect same to a computer by plugging for performing desired operations including, but not limited to, storing files, running antivirus software, locking a computer, and shutting down a computer so as to stimulate consumers' buying desires. Thus, it is desirable to provide a novel external storage device for controlling computer and method thereof.

### SUMMARY OF THE INVENTION

After considerable research and experimentation, an external storage device for controlling computer and method thereof according to the present invention has been devised so as to overcome the above drawback of the prior art pen drive.

It is an object of the present invention to provide an external storage device for controlling computer and method thereof. A message monitoring program is installed in the computer after the external storage device is connected to the computer. Thus, a user may operate an input member of the external storage device to cause the external storage device to generate a control instruction and send same to the computer. The message monitoring program runs a target program of the external storage device based on kinds of the control instruction. Therefore, the target program is adapted to cause the computer to perform a corresponding operation by running a selected one of its procedures.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of external storage device according to the invention;

FIG. 2 is a block diagram of the external storage device; and

FIG. 3 is a block diagram of a computer adapted to connect to the external storage device according to the invention.

### DETAILED DESCRIPTION OF THE PREFERRED EMBODIMENTS

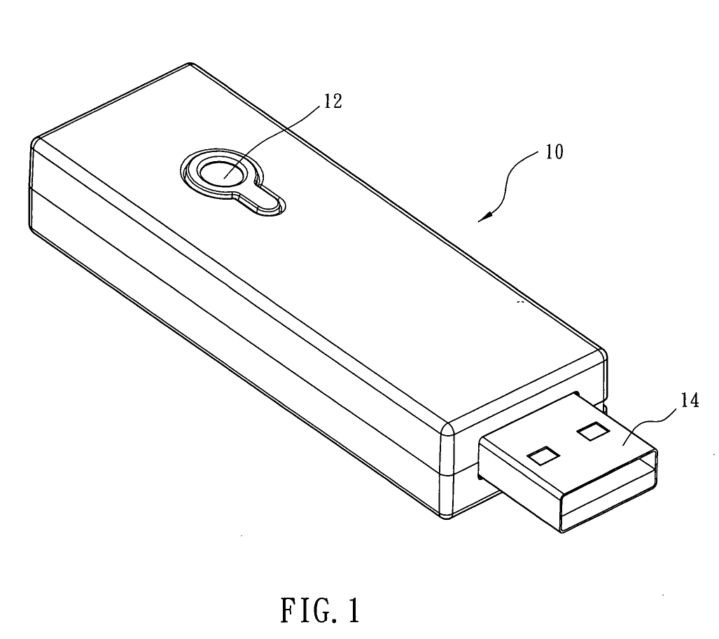

Referring to FIGS. 1, 2, and 3, an external storage device for controlling computer and method thereof in accordance with a preferred embodiment of the invention is shown and illustrated. The embodiment comprises an external storage device (e.g., a pen drive, an external diskette drive, or an external CD-ROM drive) 10. The external storage device 10 comprises at least one input member (e.g., one button as shown) 12. A user may operate (i.e., press) the input member 12 to control the external storage device 10 when the external storage device 10 is connected to a computer (e.g., a desktop computer) 20. In response, a control signal is generated in the external storage device 10. Then, a control circuit 11 of the external storage device 10 is activated to generate a corresponding control instruction in response to the control signal. The control instruction is then sent to the computer 20 connected to the external storage device 10 via a connection circuit (e.g., USB (Universal Serial Bus)) 13 of the external storage device 10. By configuring as above, the computer 20 performs a corresponding operation (e.g., file storing) by running a target program 19 stored in the external storage device 10 in response to the control instruction.

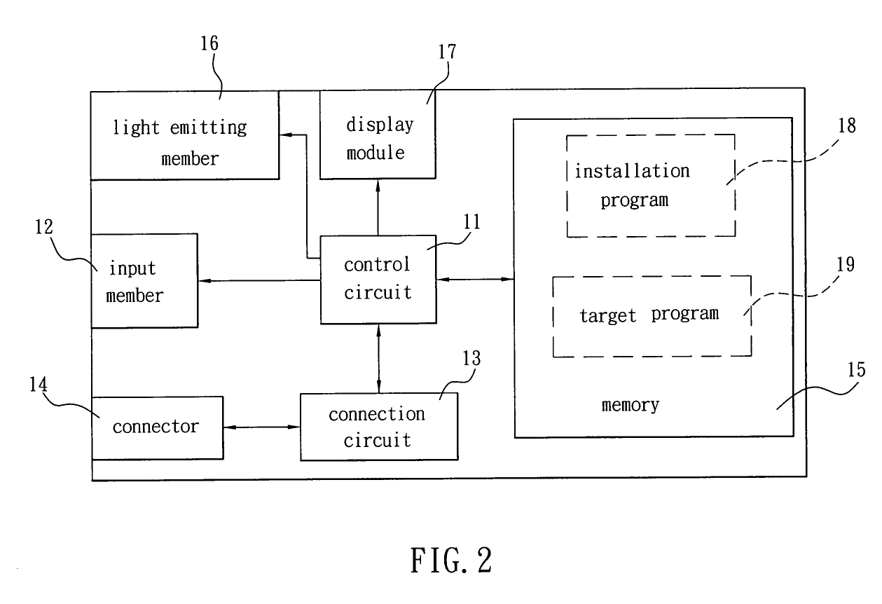

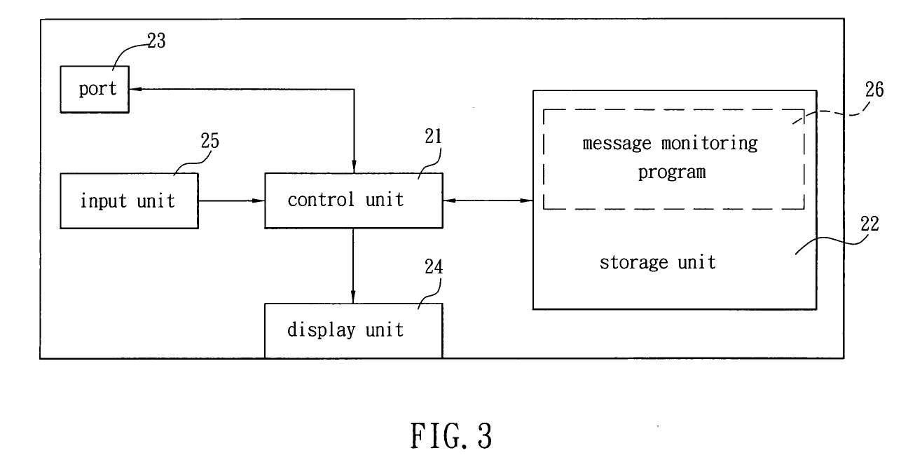

Referring to FIGS. 2 and 3 again, the external storage device 10 further comprises a memory (e.g., flash-memory or firmware) 15. The memory 15 is connected to the control circuit 11. Thus, the control circuit 11 may access data of the memory 15. The memory 15 comprises an installation program 18. The installation program 18 is adapted to install a message monitoring program 26 in a storage unit (e.g., hard disk) 22 of the computer 20 and run same in response to connecting the external storage device 10 to the computer 20, identifying the external storage device 10 by an embedded driver of the computer 20, and running the installation program 18 of the external storage device 10.

Then external storage device 10 sends the corresponding control instruction to the computer 20 when a user operates the input member 12. And in turn, the message monitoring program 26 analyzes the control instruction. Further, the message monitoring program 26 runs a selected procedure of the target program 19 on the computer 20 based on kinds of the control instruction. Therefore, a purpose of remotely controlling the computer 20 is achieved by configuring the external storage device 10 as above. For example, it is possible of running a target program (e.g., Notepad or Acrobat Reader) embedded in the computer 20 and opening a file stored in the external storage device 10 by operating the input member 12 of the external storage device 10.

Note that kinds of the target program will be described in the following paragraphs and a detailed description thereof is therefore deemed unnecessary in this paragraph. Manufacturers and companies of the external storage device 10 store the installation program 18 and the target program 19 or settings of software installed in the computer 20 on a read-only sector of a space of the memory 15.

In addition, the number and the types of the input member 12 of the external storage device 10 can be increased or decreased depending on applications. Further, functions and operations of the input members 12 can be complimentary. For example, there are two input members 12 provided in the external storage device 10. A corresponding control instruction is generated by the external storage device 10 when a user operates one input member 12. Further, another corresponding control instruction is generated by the external storage device 10 when a user operates the other input member 12. Furthermore, yet another corresponding control instruction is generated by the external storage device 10 when a user operates both input members 12. Each of the three control instructions is then sent to the computer 20. The message monitoring program then runs each of three selected procedures of the target program 19 of the computer 20 based on the control instructions.

Moreover, the input member 12 is implemented as a keypad in another embodiment. Thus, a user may operate the keypad to generate a series of control signals which are in turn sent to the computer 20 via the external storage device 10. The message monitoring program 26 then analyzes the series of control signals to run the target program 19 or a software installed in the computer 20.

Referring to FIGS. 2 and 3 again, the control circuit 11 is electrically connected to electronic components and circuits of the external storage device 10 such that the external storage device 10 may operate normally. The connection circuit 13 is electrically connected to the control circuit 11. The connection circuit 13 is adapted to electrically connect to the computer 20 by inserting a connector (e.g., USB type A connector) 14 of the external storage device 10 into a port (e.g., USB port) 23 of the computer 20. As such, the control circuit 11 is electrically connected to the computer 20 via the connection circuit 13, the connector 14, and the port 23. The input member 12 is also electrically connected to the control circuit 11. A control signal is generated and sent to the control circuit 11 when a user operates the input member 12.

Referring to FIG. 2 again, the external storage device 10 further comprises a light emitting member 16. The light emitting member 16 is provided on its outer surface and is electrically connected to the control circuit 11. The light emitting member 16 serves to indicate a state of the external storage device 10. Further, the light emitting member 16 may light or flash in response to connection states of the external storage device 10 and the computer 20. For example, the light emitting member 16 always lights when the external storage device 10 is connected to the computer 20 (see FIG. 3). Alternatively, the light emitting member 16 flashes when the external storage device 10 is connected to the computer 20 and data is transferred therebetween.

Referring to FIG. 3 again, the computer 20 further comprises a control unit 21, a storage unit 22, and an input unit 25. The control unit 21 is electrically connected to electronic components and circuits of the computer 20 such that the computer 20 may operate normally. The storage unit 22 is connected to the control unit 21. Thus, the control unit 21 may access data of the storage unit 22. The storage unit 22 has a space for storing the message monitoring program 26, text files, graphics files, video files, drivers, application software, and OS (operating system). The input unit 25 is implemented as a push button, a keypad, or a wheel. The input unit 25 is connected to the control unit 21 such that a user may operate the input unit 25 to generate a series of corresponding input signals which then are sequentially sent to the control unit 21. In response, the control unit 21 generates corresponding instructions or commands a cursor to move. The port 23 is connected to the control unit 21. The port 23 is electrically connected to the connection circuit 13 (see FIG. 2) by plugging the connector 14 (see FIG. 2) of the external storage device 10 into the computer 20. As a result, the control unit 21 is electrically connected to the control circuit 11 of the external storage device 10 via the port 23, the connector 14, and the connection circuit 13.

Referring to FIGS. 2 and 3 again, in the preferred embodiment of the invention the message monitoring program 26 comprises a state monitoring procedure and an event detecting procedure. The message monitoring program 26 can determine a connection state of the external storage device 10 and the computer 20 based on either a connection signal generated by the computer 20 when the external storage device 10 is connected to the computer 20 by plugging or a disconnection signal generated by the computer 20 when the external storage device 10 is not connected to the computer 20 by unplugging. A user may operate the input member 12 to send a control instruction from the external storage device 10 to the computer 20. Next, the event detecting procedure may run the target program 19 of the external storage device 10 in response to the control instruction. As a result, a selected procedure of the running target program 19 is adapted to control the computer 20 to perform a corresponding operation.

Referring to FIGS. 2 and 3 again, after determining that the external storage device 10 is not connected to the computer 20 and after reaching a predetermined set time, remove the message monitoring program 26 from the storage unit 22 of the computer 20 (for example, deleting the message monitoring program 26 from a hard disk (HD) or unloading the message monitoring program 26 from a RAM (Random-Access Memory)) by performing a removal procedure of the message monitoring program 26 until the external storage device 10 is connected to the computer 20 again. Thereafter, it is possible of running the installation program 18 to install the message monitoring program 26 in the computer 20. Note that in a case of the external storage device 10 not connected to the computer 20, the message monitoring program 26 may determine that the external storage device 10 is not connected to the computer 20 by running a predetermined period of time to search the disconnected external storage device 10 or analyzing a disconnection signal.

Referring to FIGS. 2 and 3 again, the message monitoring program 26 can provide a window for user viewing. The window can display information of the external storage device 10 for user inquiry. The message monitoring program 26 further provides a password check procedure for preventing unauthorized persons from gaining access to the window. A person can open the window for use only after typing a password which passes the password check procedure. Thereafter, the person can view information of the external storage device 10 or select, modify, or add procedure(s) of the target program 19 stored in the external storage device 10.

Referring to FIGS. 2 and 3 again, in the preferred embodiment of the invention it is possible of running the installation program 18 to install the message monitoring program 26 in the computer 20 when the external storage device 10 is connected to the computer 20 initially. Then the installation program 18 stores registry information (e.g., password) of the external storage device 10 in a registry of the computer 20. The registry is a core level database of Microsoft Windows (e.g., Windows 2000) and is adapted to record applications, hardware configurations, and important system settings. Thus, the computer 20 may hide information of the external storage device 10 (e.g., device name, memory capacity, or the like) based on the registry information. Moreover, after disconnecting the external storage device 10 from the computer 20 and deleting the message monitoring program 26, a user may connect the external storage device 10 to the computer 20 again. Thereafter, the computer 20 may hide information of the external storage device 10 based on the registry information stored in the registry. As such, it is possible of running the installation program 18 to install the message monitoring program 26 in the computer 20 directly by preventing a computer user from viewing information or states of the external storage device 10.

Referring to FIGS. 2 and 3 again, in the preferred embodiment of the invention procedures stored in the target program 19 are embedded in the target program 19 in advance by manufacturer of the external storage device 10. The procedures include a data backup procedure, an antivirus procedure, an OS installation procedure, an email backup procedure, a personal setting procedure of real time communication software, a shutdown procedure, a lock procedure of the external storage device 10, a lock procedure of the computer 20, etc. The procedures can be customized based on user needs. Thus, the computer 20 may perform corresponding operations based on kinds of the run procedure. For example, the target program 19 may control the computer 20 based on the data backup procedure in a data backup operation. And in turn, the computer 20 stores opened (or played) files (e.g., text files, graphics files, streaming video, or the like) in the external storage device 10. Alternatively, the running target program 19 may run antivirus software installed in the external storage device 10 (or the computer 20) to scan viruses of the computer 20 based on an antivirus procedure in an antivirus operation.

Note that the input member 12 is implemented as a button provided on the external storage device 10 in the above preferred embodiment of the invention. However, the input member 12 may be implemented as other devices in other embodiments without limitations. In other words, it is possible of altering shapes, functionalities, implementations, etc. of the input member 12 as long as the external storage device 10 is capable of generating a corresponding control signal after a user operating the input member 12. For example, the input member 12 may be implemented as a fingerprint identification member, a voice control member, an action identification member, a timer control member, a remote control member, a temperature sensing member, or the like. All of these are within the scope of the invention set forth in the claims.

While the invention herein disclosed has been described by means of specific embodiments, numerous modifications and variations could be made thereto by those skilled in the art without departing from the scope and spirit of the invention set forth in the claims.

What is claimed is:

1. An external storage device for controlling a computer by connecting thereto, comprising:
a connection circuit for being connected to the computer;
an input member for generating a control signal;
a memory including an installation program and a target program wherein, when the external storage device is connected to the computer, the computer is adapted to run the installation program to install a message monitoring program in the computer; and
a control circuit connected to the connection circuit, the input member, and the memory respectively wherein the control circuit is activated to generate a control instruction in response to the control signal fed from the input member, and the control instruction is sent to the computer via the connection circuit such that the message monitoring program is adapted to run a selected one of procedures of the target program on the computer in response to the control instruction.

2. The external storage device of claim 1, wherein the external storage device further comprises at least one light emitting member connected to the control circuit, and wherein the light emitting member is adapted to indicate a connection state of the external storage device and the computer by lighting or flashing.

3. The external storage device of claim 1, wherein the installation program stores registry information of the external storage device in a registry of the computer.

4. The external storage device of claim 1, wherein the procedures of the target program include a data backup procedure, an antivirus procedure, an OS (operating system) installation procedure, an email backup procedure, a personal setting procedure of real time communication software, a shutdown procedure, a lock procedure of the external storage device, and a lock procedure of the computer.

5. The external storage device of claim 1, wherein the input member is a button, a fingerprint identification member, a voice control member, an action identification member, a timer control member, a remote control member, or a temperature sensing member.

6. A method of controlling a computer by connecting an external storage device thereto, the external storage device adapted to perform steps comprising:
determining whether its control circuit is activated and obtains a control signal fed from its input member; and
causing the control circuit to generate a control instruction and send the control instruction to the computer via its connection circuit when the determination is positive.

7. The method of claim 6, wherein in response to connecting the external storage device to the computer, the computer is adapted to perform steps comprising:
analyzing the external storage device to run an installation program of the external storage device;
causing the message monitoring program to determine whether the computer has obtained the control instruction from the external storage device in response to running the installation program to install a message monitoring program in the computer; and
causing the message monitoring program to run a target program of the external storage device in response to the control instruction when the determination is positive such that the target program is adapted to cause the computer to perform a corresponding operation by running a selected one of its procedures.

8. The method of claim 7, wherein in response to installing the message monitoring program in the computer when the external storage device is connected to the computer initially, the installation program stores registry information of the external storage device in a registry of the computer.

9. The method of claim 8, wherein in response to disconnecting the external storage device from the computer and connecting the external storage device to the computer again, the computer hides information of the external storage device based on the registry information stored in the registry.
